(19) United States
(12) Patent Application Publication
(10) Pub. No.: US 2011/0302942 A1
(43) Pub. Date: Dec. 15, 2011

(54) ENVIRONMENT CONTROL UNIT WITH REACTIVE OXYGEN SPECIES GENERATOR

(75) Inventor: Thomas E. Birchard, Eagan, MN (US)

(73) Assignee: THERMO KING CORPORATION, Minneapolis, MN (US)

(21) Appl. No.: 12/815,814

(22) Filed: Jun. 15, 2010

(51) Int. Cl. F25B 29/00; F24F 3/14; G05D 23/00; F25D 21/06

(52) U.S. Cl. 62/159; 62/234; 236/44 C; 422/109

(57) ABSTRACT

An environment control unit including an environment control system, a reactive oxygen species (ROS) generator, and a controller. The refrigeration system and the ROS generator positioned within a housing of the environment control unit and providing conditioned air to the interior of a cargo space to clean and condition air and surfaces within the cargo space.

### BACKGROUND

The present invention relates to transporting temperature sensitive goods. Specifically, the invention relates to temperature and environmental controls for a transport refrigeration unit.

### SUMMARY

In one embodiment, the invention provides an environment control unit for controlling the environment of a cargo space of a transport container. The environment control unit includes a housing that is configured to be coupled to the transport container. An environment control system is positioned within the housing to adjust the temperature of air within the cargo space. A Reactive Oxygen Species (ROS) generator is positioned within the housing to generate reactive oxygen species in the air within the cargo space. A controller is positioned within the housing and is in electrical communication with the environmental control system and the ROS generator. The controller operates the environment control system to selectively adjust the temperature of the air within the cargo space and operates the ROS generator to selectively generate the reactive oxygen species into the air within the cargo space. Operation of the ROS generator is based on at least one operating condition of the environment control system.

In another embodiment, the invention provides an environment control unit for a transport container including a cargo space. The environment control unit includes a housing that is mounted to the transport container and defines an air return and an air supply. An environment control system is positioned within the housing at least partially between the air return and the air supply, and adjusts a temperature within the cargo space. An ROS generator is positioned within the housing and provides reactive oxygen species to the cargo space. A temperature sensor is positioned to detect a temperature indicative of the temperature within the cargo space and a reactive oxygen species sensor is positioned to detect a concentration of reactive oxygen species indicative of a concentration of reactive oxygen species within the cargo space. A controller is positioned within the housing and is in communication with the environment control system, the ROS generator, the temperature sensor, and the reactive oxygen species sensor. The controller is operable to control the environment control system and the ROS generator based at least in part on information received from the temperature sensor and the reactive oxygen species generator. A human-machine interface (HMI) is in communication with the controller and is manipulatable by a user to produce the desired environmental condition.

Other aspects of the invention will become apparent by consideration of the detailed description and accompanying drawings.

### BRIEF DESCRIPTION OF THE DRAWINGS

FIG. 1 is a perspective view of vehicle including an environment control unit according to the invention.

FIG. 2 is a perspective view of the environment control unit of FIG. 1.

FIG. 3 is a schematic of the environment control unit of FIG. 2.

FIG. 4 is a perspective view of a Reactive Oxygen Species (ROS) generator removed from the environment control unit of FIG. 2.

FIG. 5 is an exploded view of the Reactive Oxygen Species (ROS) generator of FIG. 4.

FIG. 6 is a control schematic of the environment control unit of FIG. 2.

FIG. 7 is a front view of a human-machine interface (HMI) of the environment control unit of FIG. 2.

FIG. 8 is a spreadsheet showing various environment-control parameters used by the environment control unit of FIG. 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways

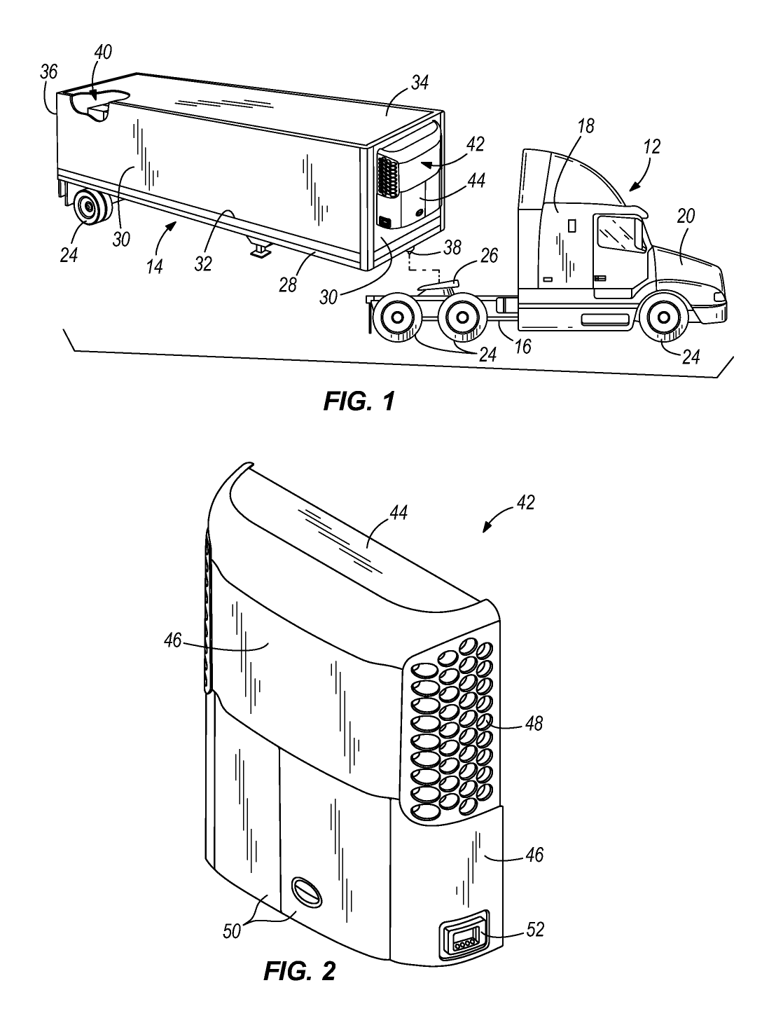

FIG. 1 shows a vehicle 10 in the form of a tractor 12 and a trailer 14. The tractor 12 includes a frame 16, a cabin 18 coupled to the frame 16 and including an engine compartment 20. An engine (not shown) and other components are mounted in the engine compartment 20. A plurality of wheels 24 are mounted to the frame 16 for rotational movement over the ground. A coupling portion 26 is defined on a rear section of the frame 16 for coupling to the trailer 14. A user drives the tractor 12 from the cabin 18.

The trailer 14 includes a frame 28 with walls 30, a floor 32, a roof 34, and rear access doors 36 attached thereto. A plurality of wheels 24 are rotatably attached to the frame 28 for movement over the ground. A coupling portion 38 is configured to couple to the tractor 12 so the trailer 14 may be pulled. The walls 30, floor 32, roof 34, and rear access doors 36 define a cargo space 40 on the interior of the trailer 14. The trailer 14 is one type of transport container. In other embodiments, the transport container could be a shipping container, a cargo container on a straight truck, a rail container, an air shipping container, or the like.

An environment control unit 42 is attached to the wall of the trailer 14. Turning to FIG. 2, the environment control unit 42 includes a housing 44 including a frame, wall panels 46, vents 48, and doors 50. A human-machine interface (HMI) 52 is positioned on the exterior of the housing 44 where it can be easily accessed by the user. Alternatively, the HMI 52 may be in a remote location or hidden from view.

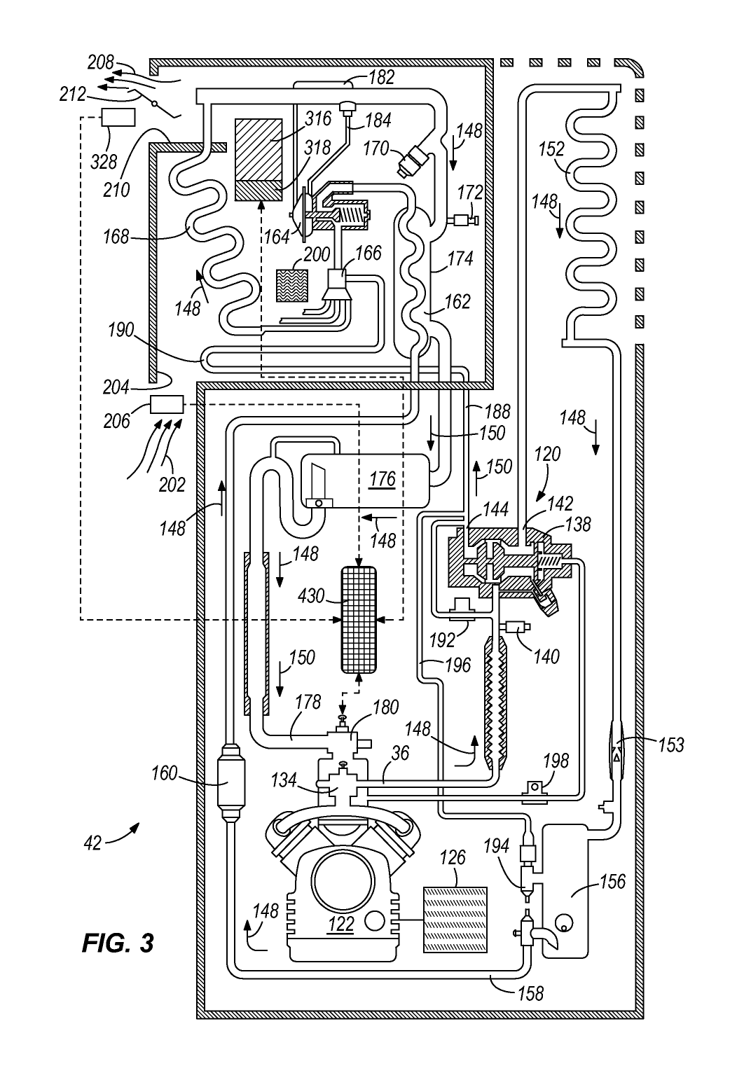

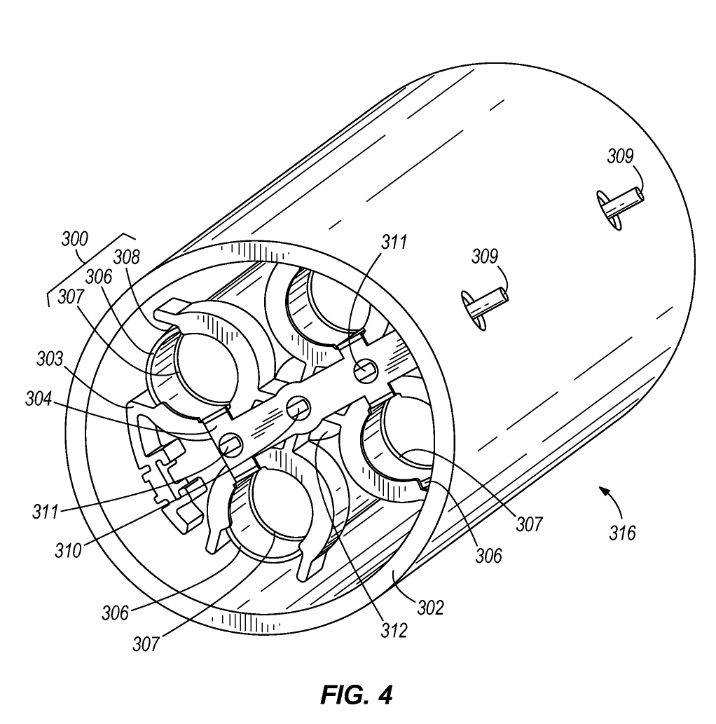

FIG. 3 shows the layout of the environment control unit 42 that includes a environment control system in the form of a closed refrigerant circuit or flow path 120, which includes a refrigerant compressor 122 driven by a prime mover in the form of an internal-combustion engine 126. The prime mover also powers a generator or other electrical device to electrically power various components of the environment control unit 42. In other embodiments, the vehicle engine can also or alternately supply power to the environment control unit 42 or elements of the environment control unit 42. Additionally, an electric motor may supply power to the environment control unit 42 or elements of the environment control unit 42. Furthermore, the environment control system may include humidity controls or other components for controlling various aspects of the environment within the cargo space 40, as desired.

A discharge valve 134 and a discharge line 136 connect the compressor 122 to a three-way valve 138. A discharge pressure transducer 140 is located along the discharge line 136, upstream from the three-way valve 138 to measure the discharge pressure of the compressed refrigerant. The three-way valve 138 includes a first outlet port 142 and a second outlet port 144.

When the environment control unit 42 is operated in a COOLING mode, the three-way valve 138 is adjusted to direct refrigerant from the compressor 122 through the first outlet port 142 and along a first circuit or flow path (represented by arrows 148). When the environment control unit 42 is operated in either a HEATING mode or a DEFROST mode, the three-way valve 138 is adjusted to direct refrigerant through the second outlet port 144 and along a second circuit or flow path (represented by arrows 150).

The first flow path 148 extends from the compressor 122 through the first outlet port 142 of the three-way valve 138, a condenser coil 152, a one-way condenser check valve 153, a receiver 156, a liquid line 158, a refrigerant drier 160, a heat exchanger 162, an expansion valve 164, a refrigerant distributor 166, an evaporator coil 168, an electronic throttling valve 170, a suction pressure transducer 172, a second path 174 through the heat exchanger 162, an accumulator 176, a suction line 178, and back to the compressor 122 through a suction port 180. The expansion valve 164 is controlled by a thermal bulb 182 and an equalizer line 184.

The second flow path 150 can bypass a section of the refrigeration circuit, including the condenser coil 152 and the expansion valve 164, and can connect the hot gas output of compressor 122 to the refrigerant distributor 166 via a hot gas line 188 and a defrost pan heater 190. The second flow path 150 continues from the refrigerant distributor 166 through the evaporator coil 168, the throttling valve 170, the suction pressure transducer 172, the second path 174 through the heat exchanger 162, and the accumulator 176 and back to the compressor 122 via the suction line 178 and the suction port 180.

A hot gas bypass valve 192 is disposed to inject hot gas into the hot gas line 188 during operation in the COOLING mode. A bypass or pressurizing line 196 connects the hot gas line 188 to the receiver 156 via check valves 194 to force refrigerant from the receiver 156 into the second flow path 150 during operation in either the HEATING MODE or the DEFROST mode.

Line 100 connects the three-way valve 138 to the low-pressure side of the compressor 122 via a normally closed pilot valve 198. When the valve 198 is closed, the three-way valve 138 is biased (e.g., spring biased) to select the first outlet port 142 of the three-way valve 138. When the evaporator coil 152 requires defrosting and when heating is required, valve 192 is energized and the low pressure side of the compressor 122 operates the three-way valve 138 to select the second outlet port 144 to begin operation in the HEATING mode and/or DEFROST modes.

A condenser fan or blower (i.e., an air moving device) directs ambient air across the condenser coil 152. Return air heated by contact with the condenser coil 152 is discharged to the atmosphere. An air moving device in the form of an evaporator fan 200 draws return air (represented by arrows 202) through an inlet 204. A return air temperature sensor 206 measures the temperature of air entering the inlet 204. An evaporator coil temperature sensor can be positioned adjacent to or on the evaporator coil 168 for recording the evaporator coil temperature. In other embodiments, the evaporator coil temperature sensor can be positioned in other locations. In still other embodiments, other sensors such as a discharge air temperature sensor can also or alternately be used. The fans can be directly coupled to the engine 126 for rotation or alternatively, they can be driven by electric motors.

Discharge air (represented by arrow 208) is returned to the cargo space 40 via outlet 210. Basically, when operating in the COOLING mode the environment control unit 42 cools the air within the housing 44 prior to being discharged into the cargo space 40 and when operating in the HEATING mode where the environment control unit 42 heats the air within the housing 44 prior to being discharged into the cargo space 40. During the DEFROST mode, a damper 212 is moved from an opened position (shown in FIG. 3) toward a closed position (not shown) to close the discharge air path to the cargo space 40 such that the environment control unit 42 heats the evaporator coil 168 to remove ice on the evaporator coil 168. Additionally, other components may be heated via the DEFROST mode to defrost the unit. The environmental control unit 42 also includes a NULL mode wherein the environmental control unit 42 does not cool or heat the air within the housing 44.

A reaction unit 316 or reactive oxygen species generator (ROS generator) is disposed between the inlet 204 and the outlet 210. The reaction unit 316 generates reactive oxygen species from oxygen (O₂) in the air received through the inlet 204. For example, a suitable reaction unit is described in U.S. Patent Publication No. 2007/0119699 (U.S. application Ser. No. 11/289,363) filed Nov. 30, 2005, the contents of which are incorporated herein in their entirety. The illustrated reaction unit 316 is shown downstream of the evaporator coil 168. In other constructions, the reaction unit 316 could be positioned upstream of the evaporator coil 168 or anywhere within the housing, as desired.

The introduction of air into the reaction unit 316 may be mediated through a forced suction or by natural suction. Preferably, the air is drawn through a filter to remove dust and other macroscopic impurities that may be present in the air to be sanitized before the air enters the reaction unit 316.

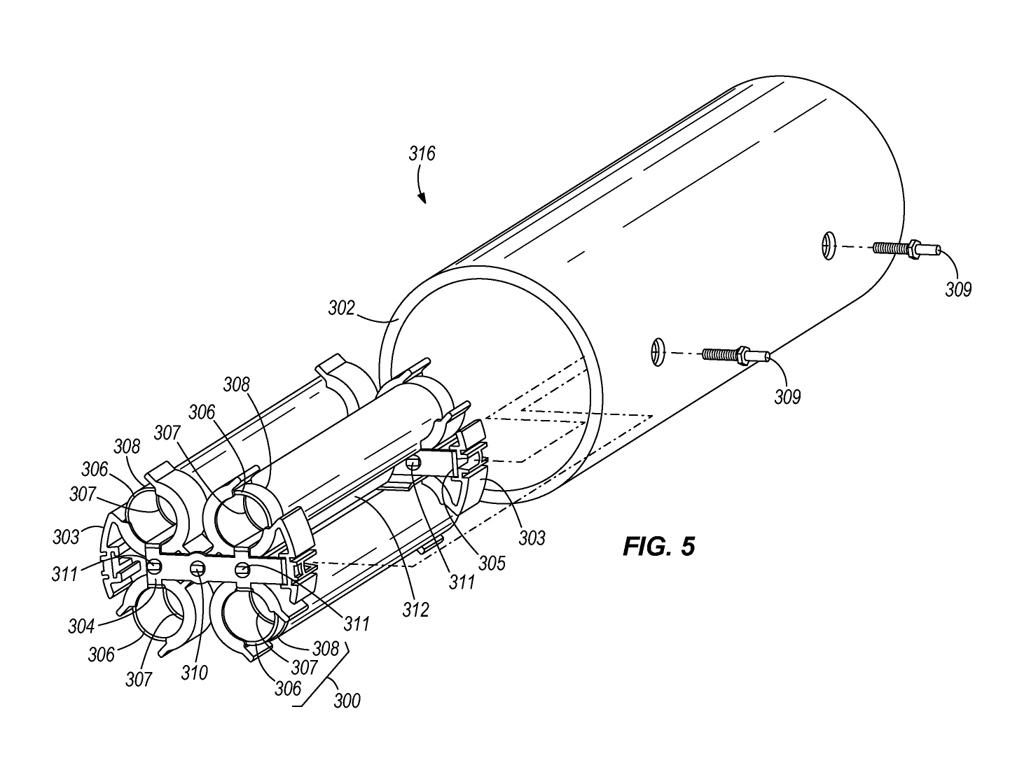

FIGS. 4 and 5 show perspective and exploded views of the reaction unit 316 of the invention. The reaction unit 316 may consist of one or more reaction chambers 300 in which the reactive oxygen species are generated. The reaction chambers 300 may be arranged in an array within a reaction unit housing 302. The reaction unit housing 302 may consist of round polyvinyl chloride (PVC) pipe of appropriate size. However, it is understood that the housing may be of any desired shape or material. For example, the reaction unit housing 302 may consist of the duct work of an HVAC system.

Preferably, the reaction chambers 300 are held in place within the array by a coupler arranged on both ends of the reaction chambers 300. The coupler may include a clamp 303 for securing the reaction chambers 300 in a desired location within the array. A center support rod 312 may be included in the array and appropriately secured by the clamp 303 to provide additional structural integrity to the array. The coupler may further include an electrically conductive contact 304, 305 cooperatively shaped with the clamp 303 and contacting each of the reaction chambers 300 within the array. The contact 304 may be integrally formed with the clamp 303 or mechanically attached to the clamp 303 by an adhesive or mechanical fasteners 311.

The coupler preferably cooperates with an inner surface of the reaction unit housing 302 to secure the reaction chambers 300 within the reaction unit housing 302. The array may be fixed within the reaction unit housing 302 using contact studs 309. The electrically conductive contact studs 309 pass through the reaction unit housing 302 and interact with the coupler so as to fixedly secure the clamp 303 in relation to the reaction unit housing 302 and electrically connect with the contacts 304, 305. In this manner, the necessary electrical connections between the reaction chamber 300 of the reaction unit 316 and the prime mover (or a generator powered by the prime mover) may be achieved through the contact studs 309. However, one of ordinary skill in the art will recognize that the necessary electrical connections may be achieved by multiple means.

As shown in FIG. 5, the reaction chamber 300 may consist of a glass tube 306 lined with an inner stainless steel mesh 307 and wrapped in an outer stainless steel mesh 308. This configuration has been found to create a very effective corona that is able to generate a large amount of reactive oxygen species without using a static discharge and without producing material amounts of off gases, such as nitrous oxide. While a round configuration for the reaction chamber is shown, the reaction chambers 300 for generating reactive oxygen species may include different configurations and materials. For example, the reaction chambers 300 may be formed of a glass tube 306 wrapped in stainless steel mesh 308 with a copper tube coated with gold inside the glass tube at specific gaps. The reaction chambers 300 may also be formed using appropriately configured plates of glass, ceramic or other materials with metal mesh on opposite sides, as desired.

The reaction unit 316 splits the oxygen in the air into large amounts of reactive oxygen species. The reactive oxygen species generated may include singlet oxygen (1O₂), ozone (O₂), atomic oxygen (O), superoxide (O₂—), hydrogen peroxide (H₂O₂), hydroxyl radical (OH—), and peroxynitrite (ONOO—). Even though many reactive oxygen species have a short half-life, they are effective sanitizing agents. Thus, as the air passes through the reaction unit 316, a large percentage of the airborne contaminants in the air are neutralized by the generated reactive oxygen species before the air is exhausted through the outlet 210. Additionally, the reactive oxygen species are carried into the cargo space 40 where they sanitize products and surfaces in the cargo space 40. In this manner, the reactive oxygen species generated in the reaction unit 316 act as a sanitizer.

One of the reactive oxygen species generated by the reaction unit 316 is ozone (O₃). The generated ozone is introduced into the air in the reaction unit 316, and the ozone also acts as a sanitizer of the air and environment. The ozone generated in the reaction unit 316 may be discharged with the air through the outlet 210. The ozone in the discharged air provides the beneficial preservative effects and acts as a sanitizer for any surfaces in the environment into which the air is discharged. Other reactive oxygen species, such as hydrogen peroxide, may also be discharged with the sanitized air and have sanitizing effects similar to ozone.

The apparatus may include a separate power supply 318 (e.g., in lieu of a generator, see FIG. 3) capable of producing high frequency and high voltage output. The power supply 318 is electrically coupled with the reaction unit 316 to create a corona discharge which splits the oxygen in the air into large amounts of reactive oxygen species. The power supply 318 provides power to the reaction unit 316.

The power supply 318 preferably includes an onboard intelligence 324 which enables the power supply 318 to adjust to changing conditions within the reaction unit 316. In embodiments with a generator, the onboard intelligence 324 operates independently. In this manner, the levels of reactive oxygen species generated within the reaction unit 316 can be maintained at desired levels regardless of changing conditions within the reaction unit 316. For example, the onboard intelligence 324 of the power supply 318 can compensate for variables that may affect the output of the reaction unit 316, such as changes in moisture content of the air to be sanitized or dust buildup within the reaction unit 316.

Further, the onboard intelligence 324 may allow for the dialing up and down of the levels of reactive oxygen species generated by the reaction unit 316. Preferably, the amount of reactive oxygen species generated by the reaction unit 316 is adjustable while maintaining continuous power to the reaction unit 316. However, one skilled in the art will recognize that the desired levels of reactive oxygen species may also be obtained by turning the reaction unit 316 on and off periodically.

The environment control unit 42 further includes a reactive oxygen species sensor 328 located adjacent the outlet 210 (see FIG. 3). In other embodiments, the reactive oxygen species sensor 328 may be positioned elsewhere (e.g., the inlet, spaced throughout the cargo space 40, etc.), as desired. The reactive oxygen species sensor 328 is used to measure pertinent variables, such as ozone levels. In the illustrated embodiment, the reactive oxygen species sensor 328 detects a concentration of ozone and generates a signal indicative of the detected concentration. Other sensors may be positioned adjacent the reactive oxygen species sensor 328 or in a different position to monitor pertinent variables such as humidity, airflow, and/or temperature of the air.

The level of ozone maintained in the cargo space 40 into which the sanitized air containing ozone is dispersed may vary from as low as 0.02 PPM to higher levels depending on regulations and operating conditions based on products in the cargo space 40.

Turning back to FIG. 3, the environment control unit 42 also includes a controller 430 (e.g., a microprocessor). For example, U.S. Pat. No. 6,862,499 filed on Sep. 11, 2000, the contents of which are incorporated herein in their entirety, describes a suitable controller and HMI 52. The controller 430 receives data from the return air temperature sensor 206, the reactive oxygen species sensor 328, the onboard intelligence 324, the environment control system, the reaction unit 316, and the HMI 52. In this way the controller 430 receives data indicative of the environment within the cargo space 40. The illustrated HMI 52 and controller 430 function with preset environment-control parameters that are selected by the user based on the products within the cargo space 40. Alternatively, the environment-control parameters can be set manually.

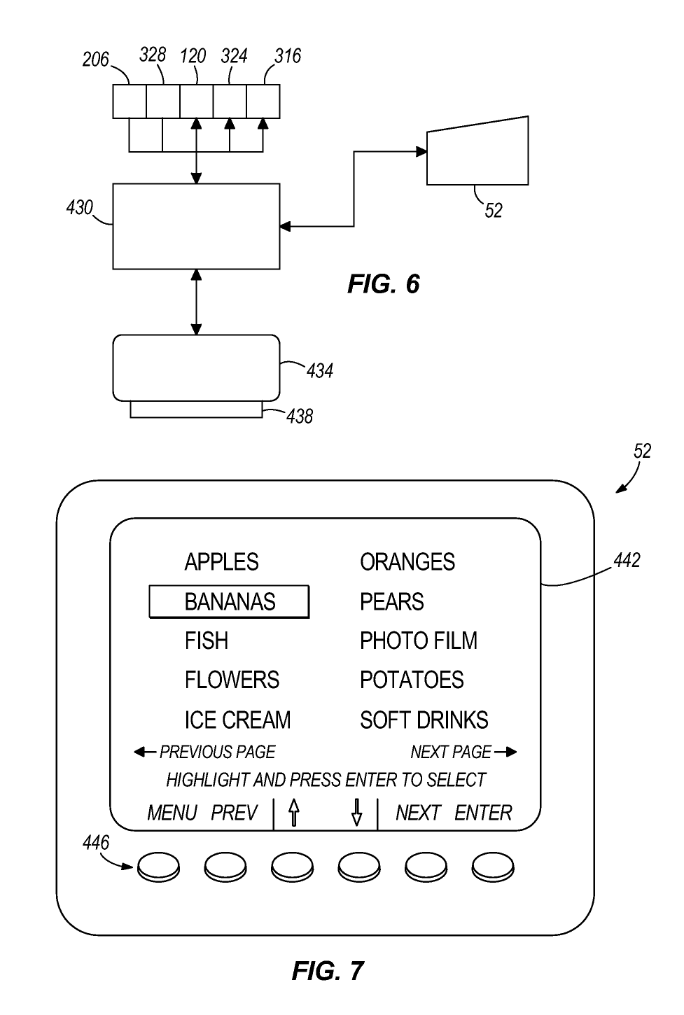

The controller 430 regulates the environment control system, in order to regulate the environment of the cargo space 40. Referring to FIG. 6, the controller 430 is coupled to memory 434 that represents any suitable computer-readable medium that stores computer-executable instructions that may be executed by the controller 430. The instructions may be stored in a machine or computer system on any machine-readable medium such as a magnetic disk or optical drive, or may be stored within non-volatile memory such as read-only memory (ROM). The memory 434 typically includes a database 438, used to store environment-control parameters used by the controller 430 to regulate the environment control system. Within the database 438, the environment-control parameters, such as set point temperature and humidity, are functions of particular products, such as ice cream, apples or soft drinks. Examples of other environment-control parameters are discussed in more detail below.

FIG. 7 shows an embodiment of the HMI 52 that includes a display screen 442 and keypad 446 may be coupled to the controller 430 via a bus. Other input/output devices may be coupled to the controller 430 via the bus in a similar fashion, such as an audible alarm that sounds if the cargo is in danger of being damaged. The display screen 442 is used among other things, to display a level of reactive oxygen species (e.g., ozone) and a level of pathogens within the cargo space 40. Various associated sensors (e.g., the reactive oxygen species sensor 328) supply information to the HMI 52 to update the display screen 442.

As will be shown below, the display screen 442 and the keypad 446 allow the user to identify the products or cargo, and the cargo identification is received by the controller 430. The cargo identification represents the products that will be hauled as cargo and stored in the cargo space 40. The user may identify, for example, cargo such as “Potatoes” or “Fish.” One way for the user to identify cargo is by making a selection from a menu, as will be described below. After the controller 430 receives the user's cargo identification, the controller retrieves the environment-control parameters as a function of the identified cargo from the database 438, or from a non-resident database. The controller 430 regulates the environment control system, and thereby regulates the cargo space 40, based upon the retrieved parameters.

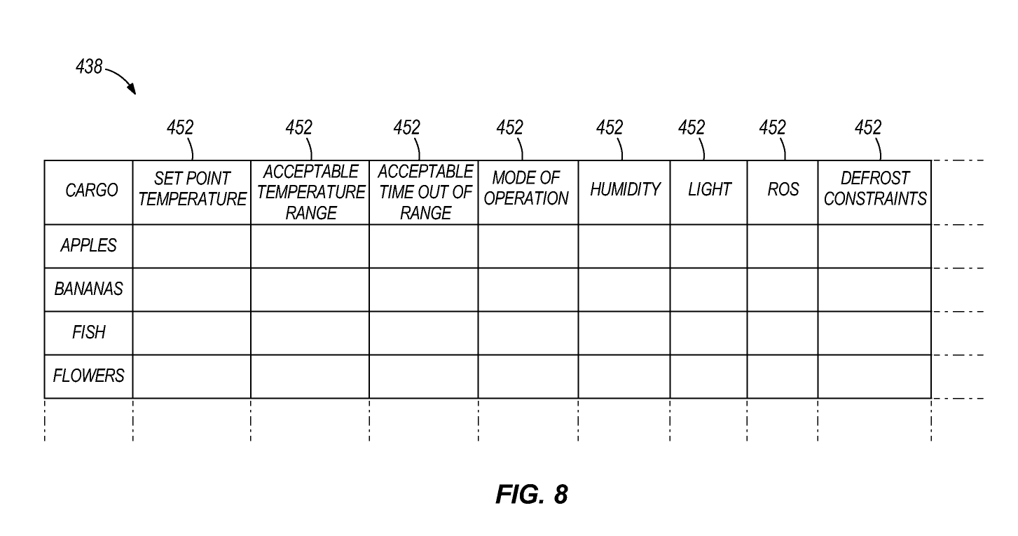

FIG. 8 illustrates an embodiment of the database 438 containing environment-control parameters 452 as a function of kinds of cargo. The cargo in the database 438 represent the products that can be hauled as cargo in the environment-controlled transport unit. Four examples of cargo are shown, but any number of cargo types can be included in the database 438. When the user identifies a particular cargo, such as by selection of a cargo option from a menu, the controller 430 finds the identified cargo in the database 438, and finds the parameters that are a function of the cargo identification.

Eight examples of environment-control parameters 452 are shown, but any data for any number of parameters may be included in the database 438. The illustrated environment-control parameters include the set point temperature and reactive oxygen species concentrations (ROS). Different kinds of cargo are best shipped at different temperatures. For example, frozen beef may be shipped at five degrees F. (−15 degrees C.) while bananas may be shipped at fifty-four degrees F. (12 degrees C.). Another environment-control parameter is an acceptable temperature range, i.e., the acceptable variance from the set point temperature. Some types of cargo, such as oranges, can be shipped at a wide range of temperatures, while other types of cargo, such as bananas, are more sensitive to temperature variations and are best transported in a narrow range of temperatures.

Some kinds of cargo require no data in the database 438 for a particular parameter. For example, light may be an unimportant factor when the cargo is fish, and thus there may be no light-regulation parameter stored in the database 438 as a function of the cargo “Fish.” As one skilled in the art will understand, many features could be controlled via the database 438, as desired. The environment-control parameters shown in FIG. 8 are not exclusive. Additional data may be stored in the database 438, including further environment-control parameters. Database 438 may also store data associated with the cargo identifications other than environment-control parameters, such as icons shown on the HMI 52 that identifying the product to the user, or foreign language names of the products.

In operation, the user selects a product from the HMI 52 which communicates with the controller 430 to control the environment control unit 42. In response to the selected product, the environment control unit 42 operates to maintain the desired environment-control parameters including temperature, humidity, reactive oxygen species concentrations, and other parameters, as desired.

The operation of the reaction unit 316 is based on at least one operating condition of the environmental control unit 42. For example, in one embodiment, the controller 430 operates the reaction unit 316 to produce reactive oxygen species only when the controller 430 operates the environmental control unit 42. In another embodiment, the controller 430 operates the reaction unit 316 such the reaction unit 316 only produces the reactive oxygen species when the controller 430 operates the environment control unit 42 in one of the COOLING mode and the HEATING mode. Furthermore, when the environmental control unit 42 is in the DEFROST mode, the controller 430 deactivates the reaction unit 316.

The controller 430 delays the operation of the reaction unit 316 until after a predetermined time period after the controller 430 operates the environment control unit 42 in the COOLING mode during a pull down operation to allow the environmental control unit 42 to remove moisture from air within the cargo space 40. The controller 430 also operates the reaction unit 316 such the reaction unit 316 begins producing the reactive oxygen species after the predetermined time period.

The environmental control unit 42 can also operate in a CLEAN mode wherein the reaction unit 316 provides the reactive oxygen species into air within the housing 44 and the reactive oxygen species are generated and discharged upstream of the evaporator coil 168 such that the reactive oxygen species flow over the evaporator coil 168 and/or other components for cleaning.

The controller 430 is responsive to the return air temperature sensor 206 to deactivate the reaction unit 316 when the detected temperature is below a threshold temperature. Additionally, the controller 430 may respond to other temperature sensors (e.g., evaporator, supply, cargo space) to deactivate the reaction unit 316 when a temperature below a threshold temperature is detected. Furthermore, the humidity within the cargo space 40 and the housing 44 may be monitored and the reaction unit 316 may be operated only when the humidity level is acceptable. For example, the reaction unit 316 may only be operated below a threshold humidity.

The evaporator fan 200 is an air moving device and may be positioned in a different location within the housing 44. When the evaporator fan 200 operates, conditioned air and reactive oxygen species are distributed from the housing 44 into the cargo space 40.

The controller 430 receives the signals sent by the reactive oxygen species sensor 328 and controls the amount of reactive oxygen species generated by the reaction unit 316 based on the detected concentration of reactive oxygen species. Specifically, the illustrated embodiment, detects the level of ozone and operates the reaction unit 316 to maintain a desired level of ozone. When operating, the evaporator fan 200 is solely responsible for moving air through both the evaporator 168 and the reaction unit 316.

The environmental control unit 42 may also include a transmitter and a receiver in communication with the controller 430. The transmitter and receiver allow the environmental control unit 42 to communicate wirelessly with a remote location. For example, the environmental control unit 42 may output operation parameters and conditions to a remote monitoring station or a user such that a particular load may be monitored while in transit. Further, the receiver may receive signals from the remote location to control the environmental control unit 42. For example, the user may desire to change an operating parameter of the environmental control unit 42 from the remote location to better protect a product in the cargo space 40.

Various features and advantages of the invention are set forth in the following claims.

What is claimed is:

1. An environment control unit for controlling the environment of a cargo space of a transport container, the environment control unit comprising:
a housing configured to be coupled to the transport container;
an environment control system positioned within the housing to adjust the temperature of air within the cargo space;
a Reactive Oxygen Species (ROS) generator positioned within the housing to generate reactive oxygen species in the air within the cargo space; and
a controller positioned within the housing and in electrical communication with the environmental control system and the ROS generator, the controller operating the environment control system to selectively adjust the temperature of the air within the cargo space and operating the ROS generator to selectively generate the reactive oxygen species into the air within the cargo space,
wherein operation of the ROS generator is based on at least one operating condition of the environment control system.

2. The environment control unit of claim 1, wherein the controller operates the ROS generator such that the ROS generator only produces the reactive oxygen species when the controller operates the environment control system.

3. The environment control unit of claim 1, wherein the environment control system includes a cooling mode where the environment control system cools the air within the housing prior to being discharged into the cargo space, a heating mode where the environment control system heats the air within the housing prior to being discharged into the cargo space, and a null mode, the controller operating the ROS generator such the ROS generator only produces the reactive oxygen species when the controller operates the environment control system in one of the cooling mode and the heating mode.

4. The environment control unit of claim 1, wherein the environment control system includes a heat exchanger in heat exchange relationship with air within the housing prior to being discharged into the cargo space, and wherein the environment control system includes a defrost mode where the environment control system heats the heat exchanger to remove ice on the heat exchanger, wherein the controller deactivates the ROS generator when the controller operates the environment control system in the defrost mode.

5. The environment control unit of claim 1, wherein the controller delays the operation of the ROS generator until after a predetermined time period after the controller operates the environment control system in a cooling mode during a pull down operation to allow the environmental control system to remove moisture from air within the cargo space, and operates the ROS generator such the ROS generator begins producing the reactive oxygen species after the predetermined time period.

6. The environment control unit of claim 1, wherein the environment control system includes a heat exchanger in heat exchange relationship with air within the housing prior to being discharged into the cargo space, and wherein the ROS generator includes a clean mode wherein the ROS generator provides the reactive oxygen species into air within the housing and the reactive oxygen species are generated and discharged upstream of the heat exchanger, the controller operating the ROS generator to selectively operate in the clean mode.

7. The environment control unit of claim 1, further comprising a temperature sensor located within one of the cargo space and the housing, the temperature sensor detects the temperature of the air and generates a signal indicative of the detected temperature, the temperature sensor in electrical communication with the controller, wherein the controller deactivates the ROS generator when the controller receives a signal indicative of detected temperature below a threshold temperature.

8. The environment control unit of claim 1, wherein the environment control system includes a heat exchanger in heat exchange relationship with air within the housing, and wherein the environment control system includes an air moving device associated with the heat exchanger, the air moving device operable to distribute the air from the heat exchanger and the ROS generator into the cargo space.

9. The environment control unit of claim 1, further comprising an ozone sensor, the ozone sensor detects the concentration of ozone and generates a signal indicative of the detected concentration, the ozone sensor in electrical communication with the controller, wherein the controller controls the amount of reactive oxygen species generated by the ROS generator based on the signal indicative of the detected concentration.

10. The environment control unit of claim 1, further comprising an human-machine interface (HMI) coupled to the housing, and wherein the HMI includes a visual display indicating one of a level of ozone within the cargo space and a level of pathogens within the cargo space.

11. The environment control unit of claim 1, further comprising a database in electrical communication with the controller, wherein the database includes control parameters for controlling the environment control system and the ROS generator organized by type of cargo, and wherein one of the control parameters includes a predetermined level of reactive oxygen species.

12. The environment control unit of claim 1, further comprising a database in electrical communication with the controller, wherein the controller stores in the database a record of operation of the ROS generator.

13. The environment control unit of claim 1, further comprising a transmitter and a receiver in electrical communication with the controller, wherein the transmitter receives signals from the controller and transmits the signals to a remote location, and wherein the receiver receives control signals and delivers the control signals to the controller to operate the ROS generator.

14. An environment control unit for a transport container including a cargo space, the environment control unit comprising:
a housing mounted to the transport container and defining an air return and an air supply;
an environment control system positioned within the housing at least partially between the air return and the air supply, the environment control system adjusting a temperature within the cargo space;
an ROS generator positioned within the housing and providing reactive oxygen species to the cargo space;
a temperature sensor positioned to detect a temperature indicative of the temperature within the cargo space;
a reactive oxygen species sensor positioned to detect a concentration of reactive oxygen species indicative of a concentration of reactive oxygen species within the cargo space;
a controller positioned within the housing and in communication with the environment control system, the ROS generator, the temperature sensor, and the reactive oxygen species sensor, the controller operable to control the environment control system and the ROS generator based at least in part on information received from the temperature sensor; and
a human-machine interface (HMI) in communication with the controller and manipulatable by a user to produce the desired environmental condition.

15. The environment control unit of claim 14, wherein a flow of air from the air return to the air supply defines a direction of flow;
wherein the environment control system includes an evaporator; and
wherein the ROS generator outputs the reactive oxygen species downstream of the evaporator.

16. The environment control unit of claim 14, further comprising a fan positioned within the housing, the fan provides a flow of air from the air return to the air supply such that air passes over at least a portion of the environment control system to adjust the temperature of the air, the reactive oxygen species enter the flow of air and are distributed throughout the cargo space.

17. The environment control unit of claim 14, wherein the environment control system includes a humidity control system that adjusts the humidity within the cargo space.

18. The environment control unit of claim 14, wherein the controller only operates the ROS generator below a threshold humidity level.

19. The environment control unit of claim 14, wherein the controller includes a plurality of preset conditions, the user is capable of selecting one of the preset conditions by manipulating the HMI; and
wherein the preset conditions include control information specifying temperature range and concentration of reactive oxygen species.

20. An environment control unit for controlling the environment of a cargo space of a transport container, the environment control unit comprising:
a housing configured to be coupled to the transport container;
an environment control system positioned within the housing to adjust the temperature of air within the cargo space, the environment control system including a heat exchanger in heat exchange relationship with air within the housing prior to being discharged into the cargo space;
a Reactive Oxygen Species (ROS) generator positioned within the housing to generate reactive oxygen species in the air within the cargo space;
a controller positioned within the housing and in electrical communication with the environmental control system and the ROS generator, the controller operating the environment control system to selectively adjust the temperature of the air within the cargo space and operating the ROS generator to selectively generate the reactive oxygen species into the air within the cargo space; and
a temperature sensor located within one of the cargo space and the housing, the temperature sensor detects the temperature of the air and generates a signal indicative of the detected temperature, the temperature sensor in electrical communication with the controller,
wherein the environment control system includes a cooling mode where the environment control system cools the air within the housing prior to being discharged into the cargo space, a heating mode where the environment control system heats the air within the housing prior to being discharged into the cargo space, a defrost mode where the environment control system heats the heat exchanger to remove ice on the heat exchanger, and a null mode,
wherein the controller operates the ROS generator such the ROS generator only produces the reactive oxygen species when the controller operates the environment control system in one of the cooling mode and the heating mode,
wherein operation of the ROS generator is based on at least one operating condition of the environment control system, and
wherein the controller deactivates the ROS generator when the controller receives a signal indicative of detected temperature below a threshold temperature.
